(19) United States
(12) Patent Application Publication
(10) Pub. No.: US 2026/0084353 A1
(43) Pub. Date: Mar. 26, 2026

(54) MOLDING MANAGEMENT SYSTEM

(71) Applicant: SEIKO EPSON CORPORATION, Tokyo (JP)

(72) Inventors: Yusuke MITSUMA, SHIOJIRI-SHI (JP); Tomohiro TAKIZAWA, MATSUMOTO-SHI (JP)

(21) Appl. No.: 19/338,645

(22) Filed: Sep. 24, 2025

(30) Foreign Application Priority Data
Sep. 26, 2024 (JP) 2024-167249

(51) Int. Cl. B29C 45/76

(52) U.S. Cl. CPC B29C 45/76; B29C 2045/7606; B29C 2945/76939; B29C 2945/76993

(57) ABSTRACT

a molding management system for managing production of a product in a production process including an injection molding process of the product by an injection molding device, the molding management system includes an information processing device communicatively connected to a terminal device, wherein the information processing device includes a storage section configured to store data relating to an injection molding and the data is associated with information unique to the injection molding device as device identification information for identifying the injection molding device.

The present application is based on, and claims priority from JP Application Serial Number 2024-167249, filed September 26, 2024, the disclosure of which is hereby incorporated by reference herein in its entirety.

### BACKGROUND

### 1. Technical Field

The present disclosure relates to a molding management system.

### 2. Related Art

Research and development have been conducted on a technique for managing production of a product in a production process including an injection molding process of the product by an injection molding device.

Here, in a case where a plurality of injection molding devices is managed via a network, a technique is known of assigning communication identification information, such as an Internet Protocol (IP) address, to each injection molding device so as not to duplicate (see JP-A-2007-304641).

However, in the technique as described in JP-A-2007-304641, sometimes communication identification information that was assigned to a certain injection molding device is mistakenly assigned to another injection molding device due to movement of the injection molding device to be managed. This is not desirable because, if the injection molding device is managed according to the communication identification information, it is not possible to know which injection molding device was the transmission source of data that was acquired in the past.

### SUMMARY

In order to solve the above problem, one aspect of the present disclosure is a molding management system for managing production of a product in a production process including an injection molding process of the product by an injection molding device, the molding management system includes an information processing device communicatively connected to a terminal device, wherein the information processing device includes a storage section configured to store data relating to an injection molding and the data is associated with information unique to the injection molding device as device identification information for identifying the injection molding device.

### BRIEF DESCRIPTION OF THE DRAWINGS

FIG. 1 is a diagram showing an example of a molding management system 1.

FIG. 2 is a diagram for explaining a method of specifying injection molding condition data to be associated with cycle data.

FIG. 3 is a diagram showing an example of a hardware configuration of an information processing device X.

FIG. 4 is a diagram showing an example of a functional configuration of the information processing device X.

FIG. 5 is a diagram showing an example of a process flow in which an information processing device 20 stores an acquired injection molding related data.

FIG. 6 is a diagram showing an example of a process flow in which the information processing device X displays a list of the injection molding related data.

FIG. 7 is a diagram showing an example of a search image P1.

FIG. 8 is a diagram showing an example of a state in which a search result list is displayed in a search result display region R1.

FIG. 9 is a diagram showing another example of a state in which the search result list is displayed in the search result display region R1.

FIG. 10 is a diagram showing a state in which one of two common IP injection molding devices is connected to the information processing device 20.

FIG. 11 is a diagram showing an example of a communication destination specifying image P2.

FIG. 12 is a diagram showing an example of a state in which a switch state shown in FIG. 11 is switched.

FIG. 13 is a diagram showing another example of the communication destination specifying image P2.

FIG. 14 is a diagram showing an example of a state in which the information processing device 20 connected to one of the two common IP injection molding devices via a switching section 50.

FIG. 15 is a diagram showing an example of a first history information.

FIG. 16 is a diagram showing an example of a second history information.

FIG. 17 is a sequence diagram showing an example of a process flow in which the information processing device 20 updates the first correspondence information and the second correspondence information described above to the latest information.

FIG. 18 is a diagram showing an example of a second correspondence information.

FIG. 19 is a diagram showing an example of a first correspondence information.

FIG. 20 is a diagram showing an example of a first correspondence information receiving image P3.

FIG. 21 is a diagram showing an example of a first correspondence information receiving image P3 in which information MS2 is displayed.

FIG. 22 is a sequence diagram showing another example of the process flow in which the information processing device 20 updates the first correspondence information to the latest information.

FIG. 23 is a diagram for explaining a specific example of a situation in which the injection molding device connected to the information processing device 20 is changed.

FIG. 24 is a diagram showing an example of the injection molding related data acquired by the information processing device 20 from the injection molding device in chronological order.

### DESCRIPTION OF EMBODIMENTS

### EMBODIMENT

Hereinafter, embodiments of the present disclosure will be described with reference to the drawings.

### Overview of molding management system

First, an overview of a molding management system according to the embodiment will be described.

The molding management system according to the embodiment manages production of a product in a production process including an injection molding process of the product by an injection molding device. The molding management system includes an information processing device. The information processing device is communicatively connected to a terminal device. The information processing device includes a storage section that stores data related to injection molding. The data is associated with information unique to the injection molding device as device identification information for identifying the injection molding device. By this, the molding management system can easily specify the injection molding device that is the transmission source of the data acquired in the past.

Hereinafter, a configuration of the molding management system according to such an embodiment and a process performed by a server included in the molding management system will be described in detail.

### Configuration of molding management system

Hereinafter, a configuration of the molding management system according to the embodiment will be described by taking a molding management system 1 as an example.

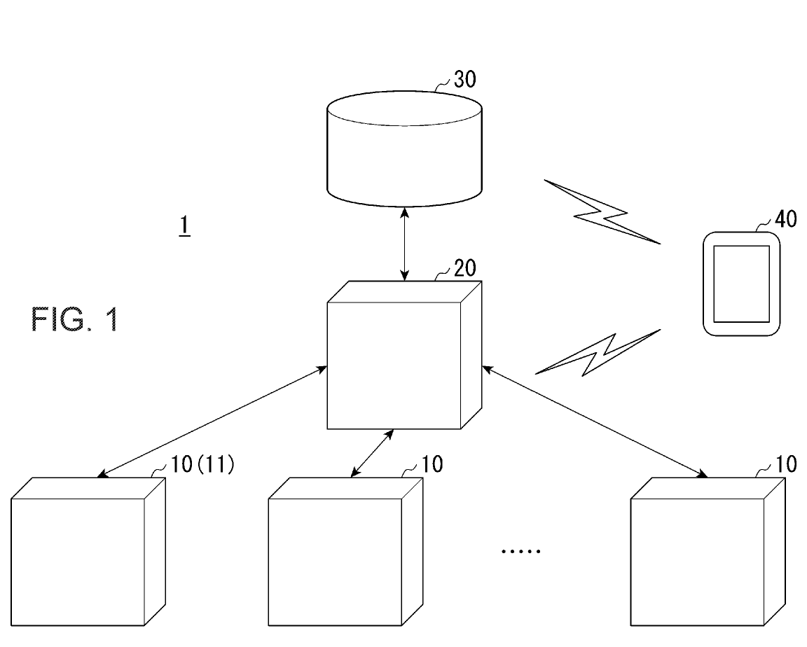

FIG. 1 is a diagram showing an example of the molding management system 1.

The molding management system 1 is a type of Manufacturing Execution System (MES). For example, the molding management system 1 includes one or more managed devices 10, an information processing device 20, and a server 30. Note that the molding management system 1 may be configured not to include a part or all of one or more managed devices 10. The molding management system 1 may be configured to include the server 30 without including the information processing device 20. The molding management system 1 may be configured to include the information processing device 20 and may not include the server 30. In the molding management system 1, the information processing device 20 may be configured integrally with the server 30. Hereinafter, as an example, a case will be described in which the molding management system 1 includes a plurality of managed devices 10 as the one or more managed devices 10. Hereinafter, as an example, a case will be described in which the molding management system 1 includes both the information processing device 20 and the server 30 separate from the information processing device 20. Note that at least one of the information processing device 20 and the server 30 is an example of an information processing device.

Each of the plurality of managed devices 10 included in the molding management system 1 is a device managed by the molding management system 1. In FIG. 1, the managed devices 10 are all indicated by the same reference symbols for convenience of description. However, some or all of the plurality of managed devices 10 may be different types of devices. The plurality of managed devices 10 includes at least one injection molding device that performs injection molding of a product using a resin such as plastic. An injection molding device 11 shown in FIG. 1 is an example of such an injection molding device. Note that the plurality of managed devices 10 may include an injection molding device that performs Metal Injection Molding (MIM) of a product. In the following description, for convenience of description, injection molding of the product using a resin such as plastic will be simply referred to as injection molding. In the following description, an injection molding device that performs injection molding of the product using a resin such as plastic will be simply referred to as an injection molding device. The plurality of managed devices 10 includes, in addition to the injection molding device, for example, a peripheral facility of the injection molding device. A peripheral facility of an injection molding device is, for example, a material supply device that supplies, to the injection molding device, a material used by the injection molding device for injection molding of the product, a transport device that transports the product injection molded by the injection molding device, a washing device that washes the product injection molded by the injection molding device, a sintering device that sinters the product after being washed by the washing device, and the like, but is not limited to these. At least one injection molding device included in the plurality of managed devices 10 may be a device that performs injection molding using a material other than resin and metal.

The molding management system 1 manages production of the product in the production process including the injection molding process of the product by the injection molding device included in the plurality of managed devices 10. Here, the injection molding device included in the plurality of managed devices 10 may have any configuration as long as the configuration enables the production of the product by injection molding. In the following description, for convenience of description, a process in which the injection molding device performs injection molding of the product once will be referred to as a cycle.

The information processing device 20 acquires various data, such as cycle data, injection molding condition data, and operational status history data from each of one or more injection molding devices included in the plurality of managed devices 10. Hereinafter, as an example, a case will be described in which three types of data, that is, the cycle data, the injection molding condition data, and the operational status history data, are acquired from each of the one or more injection molding devices by the information processing device 20. Note that the information processing device 20 independently acquires each of the three types of data. Therefore, in this example, the timings at which the three types of data are acquired by the information processing device 20 are different from each other except for a case where the timings match with each other by chance unless the timings are intentionally made to match with each other. In the following description, for convenience of description, these three types of data will be collectively referred to as injection molding related data unless it is necessary to distinguish them from each other. The injection molding related data is, in other words, data related to injection molding by the injection molding device.

For example, the information processing device 20 acquires the cycle data for each cycle. More specifically, the information processing device 20 acquires cycle data from each of the one or more injection molding devices every time each cycle ends. Here, the cycle data acquired from a certain injection molding device in a certain cycle is information including one or more pieces of cycle related information obtained according to the execution of the cycle by the injection molding device, communication identification information assigned to the injection molding device, and the first date and time information indicating the date and time acquired by the information processing device 20 from the injection molding device. Note that the cycle data may include other information in addition to the one or more pieces of cycle related information, the communication identification information, and the first date and time information. Communication identification information is information for identifying the injection molding device on a network to which the injection molding device is connected, and is, for example, an Internet Protocol (IP) address assigned to the injection molding device, but may be other information capable of identifying the injection molding device on the network. The one or more pieces of cycle related information include, for example, some or all of detection information, operational status information, production quantity information, quality information, and the like. However, the information included in the one or more pieces of cycle related information is not limited to these. The detection information included in the cycle data as the cycle related information is information detected by each of one or more various sensors attached to the injection molding device, and is, for example, a part or all of information indicating a temperature, information indicating a pressure, information indicating a current value, information indicating a voltage value, and the like. The operational status information included in the cycle data as the cycle related information is information indicating an operational status of the injection molding device. The production quantity information included in the cycle data as the cycle related information is information indicating the number of products injection molded in the cycle. The quality information included in the cycle data as the cycle related information is information indicating the quality of the product injection molded in the cycle. The first date and time information indicating the date and time acquired by the information processing device 20 from the injection molding device may be a time stamp or other information indicating the date and time. When acquiring certain cycle data, the information processing device 20 stores the acquired cycle data and outputs the acquired cycle data to the server 30. By this, the information processing device 20 can store the acquired cycle data in the server 30.

For example, the information processing device 20 acquires the injection molding condition data from each of one or more injection molding devices included in the plurality of managed devices 10 each time the injection molding condition is set in the injection molding device. Here, the injection molding condition data acquired from a certain injection molding device is information in which one or more pieces of injection molding condition information indicating the injection molding condition set in the injection molding device, the communication identification information assigned to the injection molding device, and a second date and time information indicating the date and time acquired by the information processing device 20 from the injection molding device are associated with each other. Note that the injection molding condition data may be configured to include other information in addition to the one or more pieces of injection molding condition information, the communication identification information, and the second date and time information. The one or more pieces of injection molding condition information include, for example, some or all of information indicating an injection speed, information indicating the number of rotations of a screw, information indicating a lower limit value of injection dwell pressure, information indicating an upper limit value of injection dwell pressure, and the like. However, the information included in the one or more pieces of injection molding condition information is not limited to these. The second date and time information indicating the date and time acquired by the information processing device 20 from the injection molding device may be a time stamp or other information indicating the date and time. When the information processing device 20 acquires certain injection molding condition data, the information processing device 20 stores the acquired injection molding condition data and outputs the acquired injection molding condition data to the server 30. By this, the information processing device 20 can store the acquired injection molding condition data in the server 30.

For example, the information processing device 20 acquires the operational status history data from each of one or more injection molding devices included in the plurality of managed devices 10 every time the power of the injection molding device is turned off. Here, the operational status history data acquired from a certain injection molding device is information in which operation start date and time information indicating a date and time when the power of the injection molding device is turned on, operation end date and time information indicating a date and time when the power of the injection molding device is turned off, the communication identification information assigned to the injection molding device, and third date and time information indicating a date and time when the information processing device 20 acquires the operational status history data from the injection molding device are associated with each other. Note that the operational status history data may be configured to include other information in addition to the operation start date and time information, the operation end date and time information, the communication identification information, and the third date and time information. The third date and time information indicating the date and time acquired by the information processing device 20 from the injection molding device may be a time stamp or other information indicating the date and time. The operational status history data may be a configuration included in the cycle data as the cycle related information. In this case, the operation information may be the operational status history data itself. When the information processing device 20 acquires certain operational status history data, the information processing device 20 stores the acquired operational status history data and outputs the acquired operational status history data to the server 30. By this, the information processing device 20 can store the acquired operational status history data in the server 30.

The information processing device 20 displays various images based on the injection molding related data stored in the information processing device 20 on a display section of a terminal device in response to a request from the terminal device communicably connected to the information processing device 20. Here, the image is a Graphical User Interface (GUI), an icon, a window on an Operating System (OS), or the like. Hereinafter, as an example, a case will be described in which the information processing device 20 is communicably connected to a terminal device 40 as shown in FIG. 1. Note that in the present embodiment, the process related to logging into the information processing device 20 by the terminal device 40 is a known process, and thus the description thereof will be omitted. In the following description, for convenience of description, the information processing device 20 receives an operation from the terminal device 40 via an image displayed on the terminal device 40 will be described as simply "the information processing device 20 receives an operation". That is, in the following description, the information processing device 20 performs a certain process in accordance with the received operation means that the information processing device 20 performs a process in accordance with the operation received from the terminal device 40 via the image displayed on the terminal device 40.

The information processing device 20 is, for example, a workstation, a desktop Personal Computer (PC), a notebook PC, or the like, but is not limited to these. The information processing device 20 is communicably connected to each of the plurality of managed devices 10 by wired or wireless communication. A communication network connecting the information processing device 20 and each of the plurality of managed devices 10 is, for example, a Local Area Network (LAN) in a facility in which the plurality of managed devices 10 are installed, but is not limited thereto. The communication network may be another communication network, such as the Internet or a mobile communication network.

The server 30 stores the cycle data acquired by the information processing device 20. For example, when the server 30 acquires certain cycle data from the information processing device 20, it stores the acquired cycle data.

The server 30 stores the injection molding condition data acquired by the information processing device 20. For example, when the server 30 acquires certain injection molding condition data from the information processing device 20, it stores the acquired injection molding condition data.

The server 30 stores the operational status history data acquired by the information processing device 20. For example, when the server 30 acquires certain operational status history data from the information processing device 20, it stores the acquired operational status history data.

The server 30 displays various images based on the injection molding related data stored in the server 30 on the display section of the terminal device in response to the request from the terminal device communicably connected to the server 30. Here, the image is the GUI, the icon, the window on the OS, or the like. Hereinafter, as an example, as shown in FIG. 1, a case will be described in which the server 30 is communicably connected to the terminal device 40. Note that in the present embodiment, a process related to logging into the server 30 by the terminal device 40 is a known process, and thus the description thereof will be omitted. In the following description, for convenience of description, the server 30 receiving an operation from the terminal device 40 via an image displayed on the terminal device 40 will be described as simply "the server 30 receives an operation". That is, in the following description, the server 30 performs a certain process in accordance with the received operation means that the server 30 performs the process in accordance with the operation received from the terminal device 40 via the image displayed on the terminal device 40.

As described above, in the molding management system 1, both the information processing device 20 and the server 30 cause the display section of the terminal device 40 to display various images based on the stored injection molding related data in accordance with the received operation. Therefore, in the following description, for convenience of description, the information processing device 20 and the server 30 are collectively referred to as an information processing device X unless it is necessary to distinguish them. Note that the display section is, for example, a display of the terminal device 40, a display device communicably connected to the terminal device 40, or the like, but is not limited to these. Hereinafter, as an example, a case will be described in which the display section is a display of the terminal device 40. In the following description, for convenience of description, displaying a certain image on the display section will be referred to as displaying the image.

The information processing device X extracts the injection molding condition data corresponding to the cycle data from one or more pieces of molding condition data stored in advance for each of one or more pieces of cycle data, and associates the extracted injection molding condition data with the cycle data. At this time, the information processing device X associates one piece of cycle data with one piece of injection molding condition data. That is, the information processing device X associates the cycle data with the injection molding condition data in a one-to-one or many-to-one manner. Therefore, in the information processing device X, one piece of injection molding condition data is associated with each cycle data.

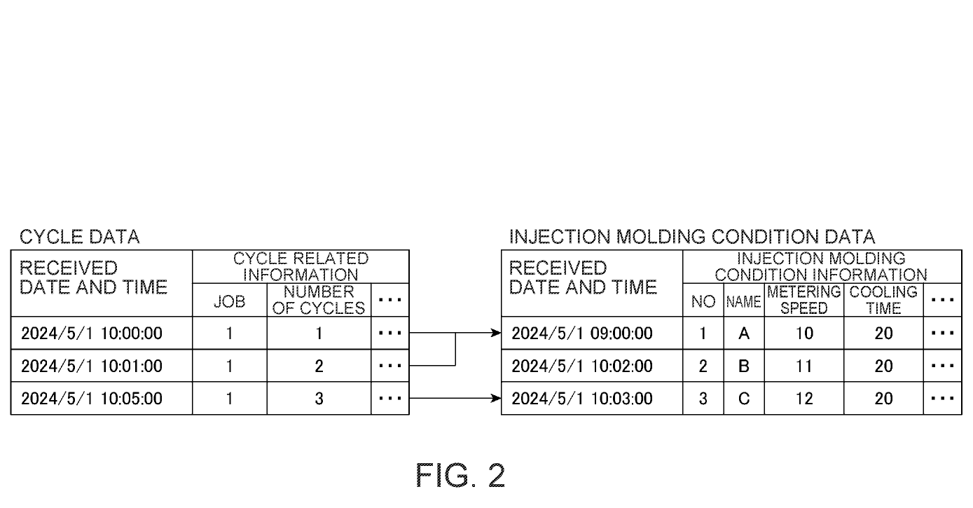

Here, a method of specifying the injection molding condition data associated with each cycle data will be described. When specifying the injection molding condition data to be associated with certain cycle data, the information processing device X extracts one or more pieces of injection molding condition data including the communication identification information included in the cycle data from one or more pieces of injection molding condition data stored in advance. Note that in this case, the information processing device X may be configured to extract one or more pieces of injection molding condition data including the device identification information (to be described later) among the information included in the cycle data from the one or more pieces of injection molding condition data. Also, the information processing device X specifies, as the injection molding condition data to be associated with the cycle data, the injection molding condition data including the second date and time information indicating the past date and time closest to the date and time indicated by the first date and time information included in the cycle data from among the extracted one or more pieces of injection molding condition data. FIG. 2 is a diagram for explaining a method of specifying injection molding condition data to be associated with cycle data. FIG. 2 shows three pieces of cycle data output from a certain injection molding device and three pieces of injection molding condition data output from the injection molding device. Specifically, FIG. 2 shows three pieces of cycle data, that is, the cycle data including first date and time information indicating 10:00:00 on May 1, 2024, the cycle data including first date and time information indicating 10:01:00 on May 1, 2024, and the cycle data including first date and time information indicating 10:05:00 on May 1, 2024. On the other hand, FIG. 2 shows three pieces of injection molding condition data, that is, the injection molding condition data including second date and time information indicating 9:00:00 on May 1, 2024 the injection molding condition data including second date and time information indicating 10:02:00 on May 1, 2024 and the injection molding condition data including second date and time information indicating 10:03:00 on May 1, 2024. For example, when the three pieces of cycle data shown in FIG. 2 are extracted by the information processing device X and the three pieces of injection molding condition data shown in FIG. 2 are stored in advance in the information processing device X, the information processing device X specifies the injection molding condition data to be associated with each of these three pieces of cycle data from among these three pieces of injection molding condition data. Specifically, the information processing device X specifies the injection molding condition data including the second date and time information indicating 09:00:00 on May 1, 2024 as the injection molding condition data associated with the cycle data including the first date and time information indicating 10:00:00 on May 1, 2024. This is because the past date and time closest to 10:00:00 on May 1, 2024 among the three dates and times of 09:00:00 on May 1, 2024, 10:02:00 on May 1, 2024, and 10:03:00 on May 1, 2024 is 09:00:00 on May 1, 2024. Similarly, the information processing device X specifies the injection molding condition data including the second date and time information indicating 09:00:00 on May 1, 2024 as the injection molding condition data associated with the cycle data including the first date and time information indicating 10:01:00 on May 1, 2024. Then, the information processing device X specifies the injection molding condition data including the second date and time information indicating 10:03:00 on May 1, 2024 as the injection molding condition data associated with the cycle data including the first date and time information indicating 10:05:00 on May 1, 2024. Therefore, in this case, the information processing device X does not specify the injection molding condition data including the second date and time information indicating 10:02:00 on May 1, 2024 as the injection molding condition data associated with any of the three pieces of cycle data shown in FIG. 2. By this, the information processing device X can omit unnecessary injection molding condition data and associate injection molding condition data necessary for a user with the cycle data. This makes it possible for the user to easily grasp the situation when an abnormality occurs in the product injection molded by the injection molding device, for example, and as a result, it is possible to easily specify the cause of the abnormality in the product. By the above described specifying method, the information processing device X can associate one piece of molding condition data with each of the three pieces of cycle data shown in FIG. 2. As a result, one piece of injection molding condition data is associated with each cycle data. In FIG. 2, the injection molding condition data associated with each cycle data is connected by an arrow. That is, in the example shown in FIG. 2, the information processing device X can associate one piece of injection molding condition data with one piece of cycle data. However, this also means that there may be a plurality of cycle data associated with a certain injection molding condition data. However, for example, when an abnormality occurs in the quality of the product molded by injection molding, the user often identifies the cause of the abnormality while viewing the cycle data. Therefore, even if the cycle data and the injection molding condition data are associated with each other in a many-to-one manner, when the number of pieces of injection molding condition data associated with each cycle data is one, the information processing device X can prevent the work required for specifying the cause of the abnormality from becoming complicated. Therefore, the information processing device X does not associate a plurality of injection molding condition data with one piece of cycle data, but associates one piece of injection molding condition data with one piece of cycle data. For example, the injection molding conditions set in the injection molding device are not usually changed during the execution of the cycle. Therefore, even if the injection molding conditions are set in the injection molding device a plurality of times before the execution of the cycle, the injection molding conditions actually set in the injection molding device at the time of the execution of the cycle are the injection molding conditions set in the injection molding device last until the execution of the cycle is started. Under such circumstances, when the injection molding device outputs certain cycle data, the injection molding condition set in the injection molding device at the time of output of the cycle data is nothing but the injection molding condition indicated by the injection molding condition data including the second date and time information indicating the past date and time closest to the date and time indicated by the first date and time information included in the cycle data. Therefore, the information processing device X associates the cycle data with the injection molding condition data by the method described above. Note that the injection molding conditions are set in the injection molding device a plurality of times before the execution of the cycle may occur when erroneous injection molding conditions are set in the injection molding apparatus, when the injection molding conditions are changed for some reason, or when trial and error is executed for obtaining better injection molding conditions. Such association between the cycle data and the injection molding condition data may be performed in the information processing device X every time the cycle data is stored in the information processing device X. Such association between the cycle data and the injection molding condition data may be performed in the information processing device X at another timing, such as a timing at which a predetermined operation is received from the user.

Note that in the following description, for convenience of description, the cycle data, the injection molding condition data, and the operational status history data acquired by the information processing device X will be collectively referred to as injection molding related data unless it is necessary to distinguish them from each other.

Here, when the information processing device 20 acquires the injection molding related data from a certain injection molding device, it stores the device identification information for identifying the injection molding device in association with the injection molding related data. Therefore, when the information processing device 20 outputs the injection molding related data to the server 30, it outputs the injection molding related data associated with the device identification information to the server 30. Therefore, the injection molding related data stored in the server 30 is associated with the device identification information. In the present embodiment, the device identification information is information that can identify the injection molding device and is information unique to the injection molding device. Therefore, among the communication identification information associated with the injection molding device, the communication identification information that can be changed by the user, the device name information indicating the name assigned to the injection molding apparatus, and the like cannot be used as the device identification information because they may be changed for management reasons of the injection molding device. Note that among the communication identification information, the communication identification information that is assigned to the injection molding device so as not to be changed, such as a MAC address, can be used as the device identification information. The information that can be used as the device identification information is, for example, a serial number, a Media Access Control (MAC) address, a model number, an ID, or the like assigned to the injection molding device. The device identification information does not need to be a single piece of information, and may be plural pieces of information. That is, the device identification information is at least one of the serial number, the Media Access Control (MAC) address, the model number, the ID, and the like assigned to the injection molding device. Hereinafter, for simplification of description, a case will be described as an example in which the device identification information is the MAC address assigned to the injection molding device. As described above, in the molding management system 1, since the device identification information is associated with the injection molding related data, even when the communication identification information has been changed once or more in the past for management reasons, the information processing device X can easily specify the injection molding related data from which the injection molding device each injection molding related data has been acquired. In other words, the information processing device X can easily specify the injection molding device that is a transmission source of the injection molding related data acquired in the past. This is an effect that cannot be obtained when information that may be changed due to management reasons, such as an IP address, is used as the device identification information. Note that even when storing certain data other than the injection molding related data among the data acquired from a certain injection molding device, the information processing device 20 may be configured to store the device identification information for identifying the injection molding device in association with the data. In this case, the information processing device X can easily specify the injection molding device of the transmission source of various data acquired in the past.

### Hardware configuration of information processing device X

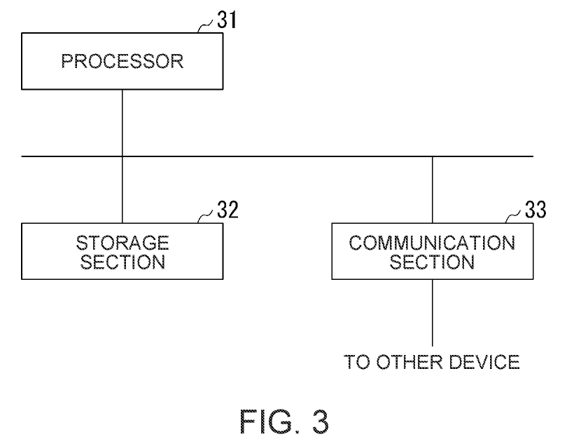

Here, the information processing device 20 and the server 30 may have the same hardware configuration or different hardware configurations. Hereinafter, as an example, a case will be described in which the information processing device 20 and the server 30 have the same hardware configuration. In other words, in this example, the information processing device X has a hardware configuration as shown in FIG. 3. FIG. 3 is a diagram showing an example of the hardware configuration of the information processing device X.

The information processing device X includes, for example, a processor 31, a storage section 32, and a communication section 33. These components are communicatively connected to each other via a bus. The information processing device X communicates with other devices via the communication section 33. The other device is, for example, in a case where the information processing device X is the information processing device 20, the injection molding device, the server 30, the terminal device 40, or the like. The other device is, for example, the terminal device 40, or the like in a case where the information processing device X is the server 30, the information processing device 20.

The processor 31 is, for example, a Central Processing Unit (CPU). Note that the processor 31 may be another processor, such as a Field Programmable Gate Array (FPGA), instead of the CPU. The processor 31 executes various programs stored in the storage section 32.

The storage section 32 is a storage device including, for example, a Hard Disk Drive (HDD), a Solid State Drive (SSD), an Electrically Erasable Programmable Read Only Memory (EEPROM), a Read Only Memory (ROM), a Random Access Memory (RAM), and the like. Note that the storage section 32 may be an external storage device connected by a digital input and output port, such as a Universal Serial Bus (USB), instead of being built in the information processing device X. The storage section 32 stores various types of information, various images, and various programs processed by the information processing device X. That is, various information stored in the information processing device X are stored in the storage section 32.

The communication section 33 is a communication device that includes, for example, a digital input and output port, such as a USB, an Ethernet (registered trademark) port, an antenna for wireless communication, and the like.

### Functional configuration of information processing device X

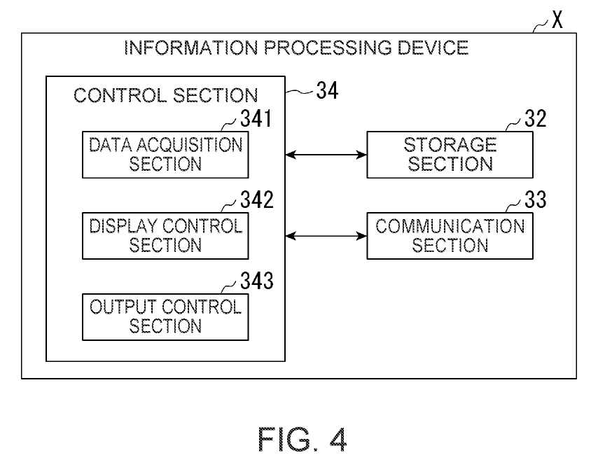

Here, the information processing device 20 and the server 30 may have the same functional configuration or different functional configurations. Hereinafter, as an example, a case will be described in which the information processing device 20 and the server 30 have the same functional configuration. In other words, in this example, the information processing device X has the functional configuration as shown in FIG. 4. FIG. 4 is a diagram showing an example of the functional configuration of the information processing device X.

The information processing device X includes the storage section 32, the communication section 33, and a control section 34.

The control section 34 controls the information processing device X as a whole. The control section 34 includes at least a data acquisition section 341, a display control section 342, and an output control section 343. These functional sections of the control section 34 are realized, for example, by the processor 31 executing various programs stored in the storage section 32. Some or all of the functional sections may be hardware functional sections, such as a Large Scale Integration (LSI) and an Application Specific Integrated Circuit (ASIC).

The data acquisition section 341 acquires various data from devices communicably connected to the information processing device X. The device is, for example, the injection molding device, the information processing device 20, or the like.

The display control section 342 generates various images in accordance with the received operation. The display control section 342 transmits the generated image to the terminal device 40 and causes the terminal device 40 to display the image.

The output control section 343 outputs various data to another device in accordance with the received operation. For example, the output control section 343 outputs the injection molding related data to another device.

### Process of storing acquired injection molding related data by information processing device 20

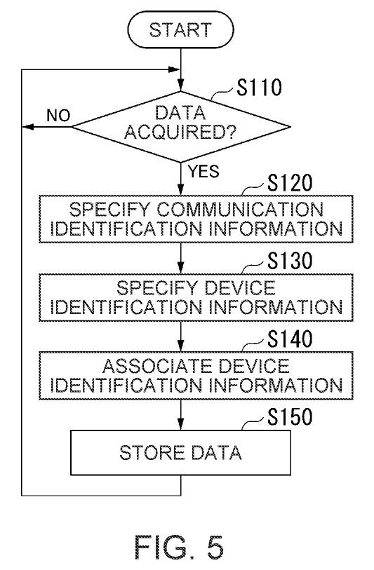

A process in which the information processing device 20 stores the acquired injection molding related data will be described with reference to FIG. 5. FIG. 5 is a diagram showing an example of a process flow in which the information processing device 20 stores the acquired injection molding related data. Hereinafter, as an example, a case will be described in which, at a timing before the process of step S110 shown in FIG. 5 is performed, the first correspondence information in which the device identification information for identifying the injection molding device and the communication identification information assigned to the injection molding device are associated with each other is stored in the storage section 32 for all the injection molding devices connected to the information processing device 20. Here, the first correspondence information is information in which the device identification information and the communication identification information are associated with each other for each set of device identification information. Note that the method by which the information processing device 20 stores the first correspondence information in the storage section 32 may be a known method or a method to be developed in the future. For example, the information processing device 20 stores the device identification information specified by the operation from the user and the communication identification information specified by the operation from the user in the storage section 32 as the first correspondence information in association with each other. For example, the information processing device 20 may be configured to store the first correspondence information in the storage section 32 as the information included in a master data or may be configured to store the first correspondence information in the storage section 32 as other information. Details of the first correspondence information will be described later. The information processing device 20 repeatedly executes the process of the flowchart shown in FIG. 5, for example, while the power of the information processing device 20 is on.

The control section 34 waits until the injection molding related data is acquired (step S110). In FIG. 5, the process of step S110 is indicated by "DATA ACQUIRED?".

When the control section 34 determines that the injection molding related data has been acquired (YES in step S110), it specifies the communication identification information included in the acquired injection molding related data (step S120). In FIG. 5, the process of step S120 is indicated by "SPECIFY COMMUNICATION IDENTIFICATION INFORMATION".

Next, the control section 34 specifies the device identification information associated with the communication identification information based on the communication identification information specified in step S120 and the first correspondence information stored in advance in the storage section 32 (step S130). In FIG. 5, the process of step S130 is indicated by "SPECIFY DEVICE IDENTIFICATION INFORMATION".

Next, the control section 34 associates the device identification information identified in step S130 with the injection molding related data acquired in step S110 (step S140). In FIG. 5, the process of step S140 is indicated by "ASSOCIATE DEVICE IDENTIFICATION INFORMATION".

Next, the control section 34 stores the injection molding related data associated with the device identification information in step S140 in the storage section 32 (step S150). In FIG. 5, the process of step S150 is indicated by "STORE DATA". After the process of step S150 is performed, the control section 34 transitions to step S110 and waits again until the injection molding related data is acquired.

In this way, the injection molding related data associated with the device identification information is stored in the storage section 32 of the information processing device X. As a result, the information processing device X can easily specify the injection molding device that is the transmission source of the data acquired in the past. Note that the injection molding related data acquired by the information processing device 20 from a certain injection molding device may be configured to already include the device identification information of the injection molding device before the device identification information of the injection molding device is associated by the information processing device 20. In this case, the injection molding device outputs the injection molding related data, including the device identification information, to the information processing device 20. In this case, the information processing device 20 may be configured not to perform the process of the flowchart shown in FIG. 5.

### Process of displaying list of injection molding related data by information processing device X

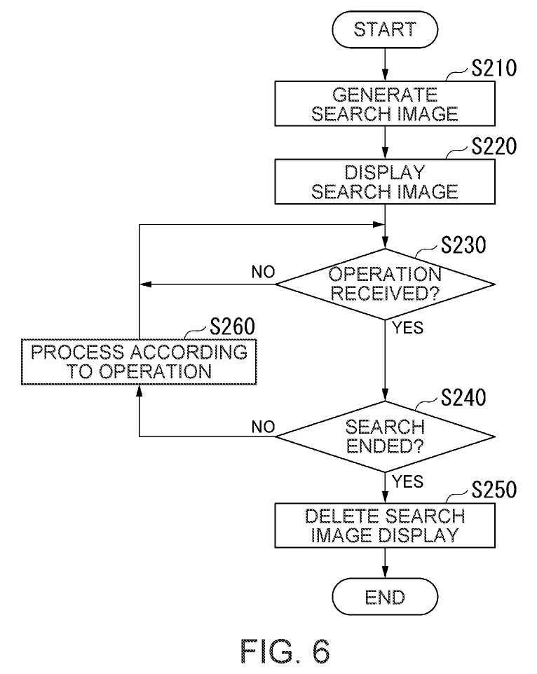

Hereinafter, a process in which the information processing device X displays a list of injection molding related data will be described with reference to FIG. 6. That is, hereinafter, a process in which the information processing device X searches for the injection molding related data according to the received operation will be described. FIG. 6 is a diagram showing an example of a process flow in which the information processing device X displays the list of the injection molding related data. In the following, as an example, a case will be described in which, at a timing before the process of step S210 shown in FIG. 6 is performed, the type of injection molding related data to be searched is stored in the information processing device X. Hereinafter, as an example, a case will be described in which the information processing device X receives an operation of selecting the type of the injection molding related data to be searched at the timing. The operation of selecting the type of the injection molding related data is, that is, an operation of selecting any one of the cycle data, the injection molding condition data, and the operational status history data. In the following description, for convenience of description, the type of injection molding related data selected by the operation is referred to as search target injection molding related data. Hereinafter, as an example, a case will be described in which the information processing device X receives an operation of displaying a search image P1 at the timing. The search image P1 is an image for receiving an operation of causing the information processing device X to search for the search target injection molding related data desired by the user, among the search target injection molding related data to be searched, stored in the storage section 32. Here, the search image P1 will be described.

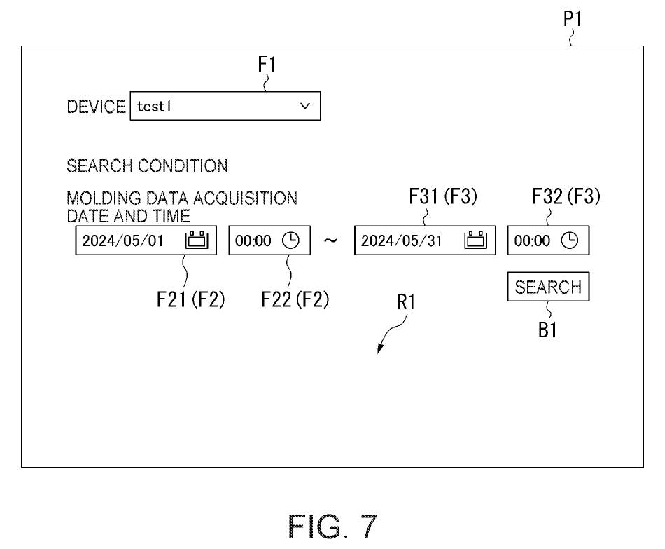

FIG. 7 is a diagram showing an example of the search image P1. In the example shown in FIG. 7, the search image P1 includes an input field F1, an input field F2, an input field F3, a button B1, and a search result display region R1. Note that the search image P1 may be configured to include another Graphical User Interface (GUI) capable of receiving the operation of searching the search target injection molding related data, instead of a part or all of these GUIs, or in addition to all of these GUIs. In the following description, for convenience of explanation, various operations received by the information processing device X via the search image P1 are collectively referred to as search operations.

The input field F1 is a field in which is input the device name information assigned to the injection molding device that has output the search target injection molding related data desired by the user. Here, the device name information assigned to a certain injection molding device is information indicating a name assigned to the injection molding device. The name is assigned to the injection molding device so as not to be duplicated in a factory or the like, for example, for management reasons of the injection molding device. In the master data stored in the information processing device X, names are assigned to the injection molding devices so as not to cause duplication. In the example shown in FIG. 7, "test1" is input to the input field F1 as an example of the device name information. Note that the device name information may be input in the input field F1 by selecting the device name information from a pull-down menu or by directly inputting the device name information using an input device such as a keyboard.

The input field F2 and the input field F3 are fields in which period information indicating a period including a date and time when the search target injection molding related data desired by the user is acquired by the information processing device 20 is input. In the example shown in FIG. 7, the input field F2 is a field in which is input start date and time information that indicates the date and time when the period starts. In the present example, the input field F3 is a field in which is input end date and time information that indicates the date and time when the period ends.

More specifically, the input field F2 is composed of two input fields, an input field F21, and an input field F22. The input field F21 is a field in which is input start date information indicating a date among the date and time information indicated by the start date and time information described above. In the example shown in FIG. 7, in the input field F21, "2024/05/01" indicating May 1, 2024, is input as an example of the start date information. Note that the start date information may be input to the input field F21 by selecting information from a pull-down menu, by selecting a date from an image showing a calendar, or by directly inputting using the input device such as the keyboard. On the other hand, the input field F22 is a field in which is input start time information indicating a time among the date and time information indicated by the start date and time information. In the input field F22, "00:00" indicating 0:00 is input as an example of the start time information. Note that the start time information may be input to the input field F22 by selecting information from a pull-down menu, by specifying a time using an image representing a watch, or by directly inputting information using an input device such as a keyboard.

The input field F3 is composed of two input fields, an input field F31, and an input field F32. The input field F31 is a field in which is input end date information indicating a date among the date and time information indicated by the end date and time information. In the example shown in FIG. 7, in the input field F31, "2024/05/31" indicating May 31, 2024, is input as an example of the end date information. Note that the end date information may be input to the input field F31 by selecting information from a pull-down menu, by selecting a date from an image showing a calendar, or by directly inputting information using an input device such as a keyboard. On the other hand, the input field F32 is a field in which is input end time information indicating a time among the date and time information indicated by the end date and time information. In the input field F32, "00:00" indicating 0:00 is input as an example of the end time information. Note that the end time information may be input to the input field F32 by selecting information from a pull-down menu, by specifying a time using an image representing a watch, or by directly inputting information using an input device such as a keyboard.

The button B1 is a button that receives an operation of executing a search of the target type injection molding related data based on search keys, with each piece of information input to a part or all of the input field F1 to the input field F3 as the search keys. That is, when the information processing device X receives the selection operation on the button B1, the information processing device X extracts one or more pieces of the search target injection molding related data to be search corresponding to each information inputted in a part or all of the input field F1 to the input field F3 as the search result. The information processing device X displays a list of the extracted one or more pieces of the search target injection molding related data in the search result display region R1. Note that in the present embodiment, the selection operation is a click, a tap, or the like, but is not limited to these. The search image P1 shown in FIG. 7 is an image before the extraction of the one or more pieces of search target injection molding related data is executed. Therefore, nothing is displayed in the search result display region R1 shown in FIG. 7. In the following description, for convenience of description, the list of the one or more pieces of search target injection molding related data extracted by the information processing device X will be simply referred to as a search result list. Note that the method of extracting one or more pieces of search target injection molding related data according to the information input in some or all of the input field F1 to the input field F3, that is, the method of searching for the one or more pieces of search target injection molding related data may be a known method or a method to be developed in the future. Therefore, in the present embodiment, a detailed description of the extraction method will be omitted. Note that when the selection operation is performed on the button B1 in a case where information is not input to all of the input field F1 to the input field F3, the information processing device X may be configured to display the list of all of one or more pieces of the search target injection molding related data stored in advance as a search result list in the search result display region R1, or may be configured not to display anything in the search result display region R1.

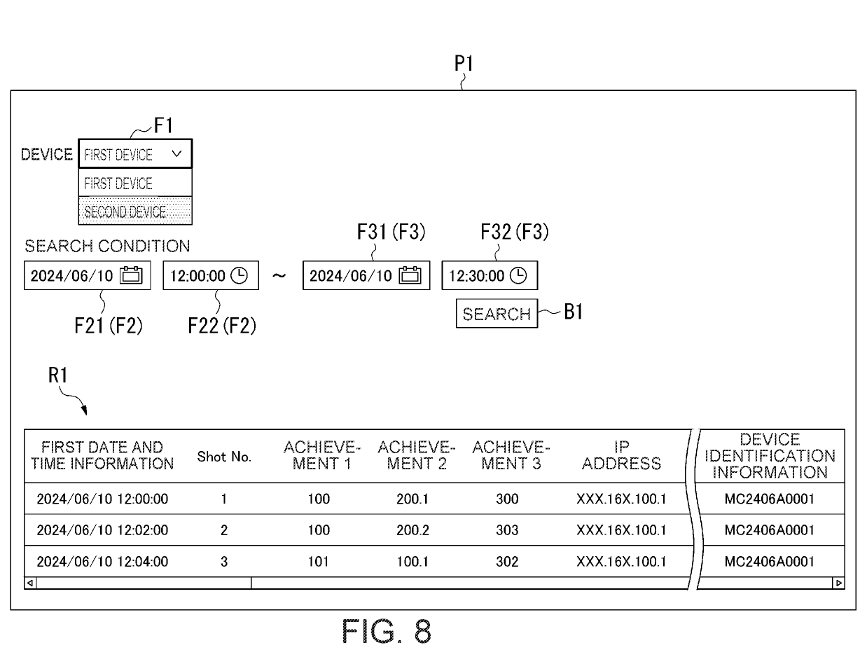

FIG. 8 is a diagram showing an example of a state in which the search result list is displayed in the search result display region R1. In the example shown in FIG. 8, "FIRST DEVICE”, which is the device name information selected by the pull-down menu, is displayed in the input field F1. In the input field F2, information indicating 12:00:00 on Jun. 10, 2024 is displayed as the start date and time information. In the input field F3, information indicating 12:30:00 on Jun. 10, 2024 is displayed as the end date and time information. Therefore, in response to the selection operation on the button B1, the information processing device X displays, in the search result display region R1, three target type injection molding related data acquired from the injection molding device to which the name "FIRST DEVICE" is assigned from 12:00:00 on Jun. 10, 2024 to 12:30:00 on Jun. 10, 2024. Note that in the example shown in FIG. 8, the target type injection molding related data is the cycle data. In the present example, all of the three cycle datasets displayed in the search result display region R1 are datasets acquired from a common injection molding device. This can be easily specified because the device identification information included in each of the three-cycle data displayed in the search result display region R1 shown in FIG. 8 is the same.

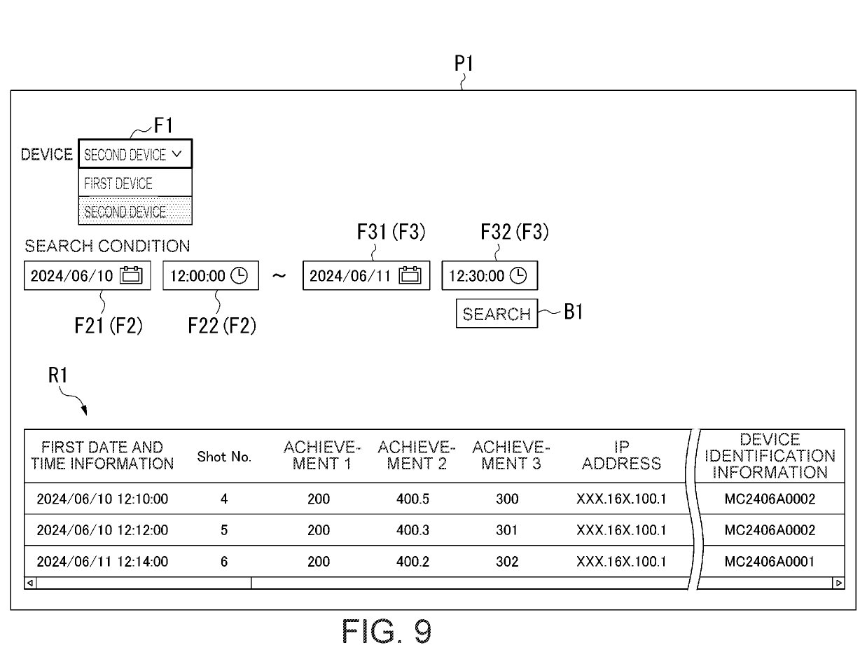

On the other hand, FIG. 9 is a diagram showing another example of a state in which the search result list is displayed in the search result display region R1. In the example shown in FIG. 9, "SECOND DEVICE", which is the device name information selected by the pull-down menu, is displayed in the input field F1. In the input field F2, information indicating 12:00:00 on Jun. 10, 2024 is displayed as the start date and time information. In the input field F3, information indicating 12:30:00 on Jun. 11, 2024 is displayed as the end date and time information. Therefore, in response to the selection operation on the button B1, the information processing device X displays, in the search result display region R1, three target type injection molding related data acquired from the injection molding device to which the name "SECOND DEVICE" is assigned from 12:00:00 on Jun. 10, 2024 to 12:30:00 on Jun. 11, 2024. Note that in the example shown in FIG. 9, the target type injection molding related data is cycle data. In the present example, each of the three cycle datasets displayed in the search result display region R1 is obtained from one of the two injection molding devices. This can be easily specified because the device identification information included in the two cycle datasets displayed in the search result display region R1 shown in FIG. 9 is "MC2406A0002", while the device identification information included in the remaining one cycle dataset is "MC24060001". In this way, since the device identification information is included in the injection molding related data stored in the storage section 32, the information processing device X can easily specify the injection molding device of the transmission source of the data acquired in the past.

Note that instead of a configuration in which the information processing device X searches for target type injection molding related data including the device name information inputted in the input field F1 in response to the operation received via the search image P1, the information processing device X may be configured to identify the device identification information associated with the device name information and search for target type injection molding related data including the identified device identification information. In this case, the information processing device X stores, for each set of device identification information, second correspondence information that associates the device identification information with the device name information in the storage section 32. In this case, even if the user does not remember the device identification information, the user can cause the terminal device 40 or the like to display a list of the target type injection molding related data acquired by the information processing device 20 from the injection molding device desired by the user. Note that the method by which the information processing device X stores the second correspondence information in the storage section 32 may be a known method or a method to be developed in the future. The target type injection molding related data included in the list of the target type injection molding related data displayed in this manner includes the common device identification information, for example, as in the list of the target type injection molding related data displayed in the search result display region R1 shown in FIG. 9. Therefore, in the present embodiment, in this case, description by illustration of the list of the target type injection molding related data displayed in the search result display region R1 will be omitted. The second correspondence information will be described in detail later.

Return to FIG. 6. When the operation of displaying the search image P1 is received, the control section 34 generates the search image P1 (step S210). Note that the method by which the control section 34 generates the search image P1 may be a known method or a method to be developed in the future. In FIG. 6, the process of step S210 is indicated by "GENERATE SEARCH IMAGE".

Next, the control section 34 displays the search image P1 generated in step S210 (step S220). In FIG. 6, the process of step S220 is indicated by "DISPLAY SEARCH IMAGE".

Next, the control section 34 waits until an operation is received via the search image P1 displayed in step S220 (step S230). In FIG. 6, the process of step S230 is indicated by "OPERATION RECEIVED?".

When the control section 34 determines that the operation has been received via the search image P1 displayed in step S220 (step S230: YES), the control section 34 determines whether or not the received operation is an operation of ending the search for the target type injection molding related data (step S240). In FIG. 6, the process of step S240 is indicated by "SEARCH ENDED?".

When the control section 34 determines that an operation received in step S230 is the operation of ending the search for the target type injection molding related data (step S240: YES), the control section 34 deletes the display of the search image P1 in the terminal device 40 (step S250), and ends the process of the flowchart shown in FIG. 6. In FIG. 6, the process of step S250 is indicated by "DELETE SEARCH IMAGE DISPLAY".

On the other hand, when the control section 34 determines that an operation received in step S230 is not the operation of ending the search for the target type injection molding related data (step S240: NO), the control section 34 performs process according to the operation received in step S230 (step S260). Note that the process is, for example, a process performed by the information processing device X in response to a selection operation on each GUI included in the search image P1 shown in FIG. 7. In FIG. 6, the process of step S260 is indicated by "PROCESS ACCORDING TO OPERATION". After the process of step S260 is performed, the control section 34 transitions to step S230 and waits again until an operation is received via the search image P1 displayed in step S220.

As described above, the information processing device X can display the list of injection molding related data desired by the user.

### About switching of injection molding device connected to information processing device 20

The information processing device 20 may be configured to be able to switch which of the plurality of injection molding devices to which the common communication identification information is assigned to communicate with, according to various circumstances. In the following description, for convenience of description, the plurality of injection molding devices to which the common communication identification information is assigned will be referred to as the common IP injection molding device. In the case of such a configuration, the information processing device 20 stores the device identification information in association with the injection molding related data, and thus, it is not necessary to cause the user to associate information indicating from which of the plurality of common IP injection molding devices each injection molding related data is acquired with each injection molding related data. This is useful because it leads to a reduction of time and effort for the management of the plurality of common IP injection molding devices. This also means that management of the plurality of common IP injection molding devices can be performed by a person who lacks knowledge of the network, which is useful.

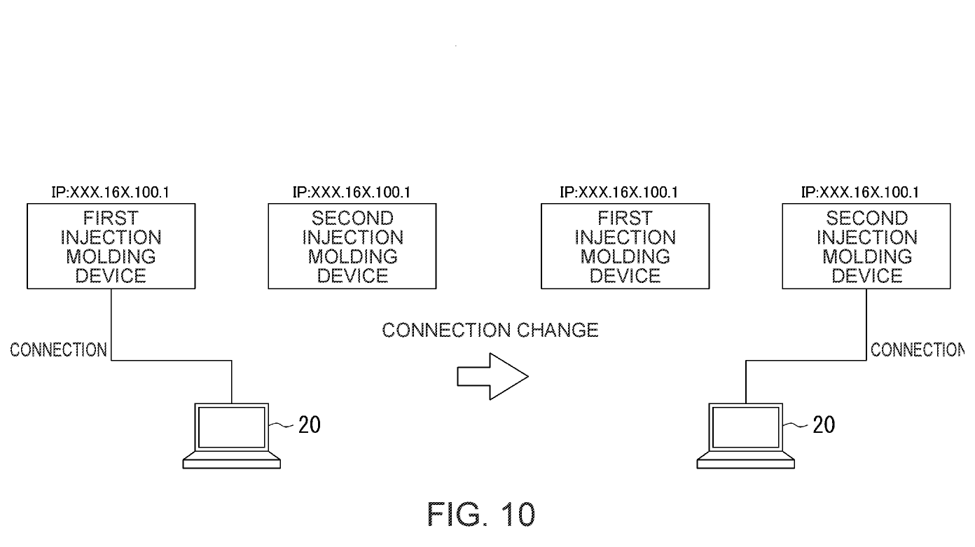

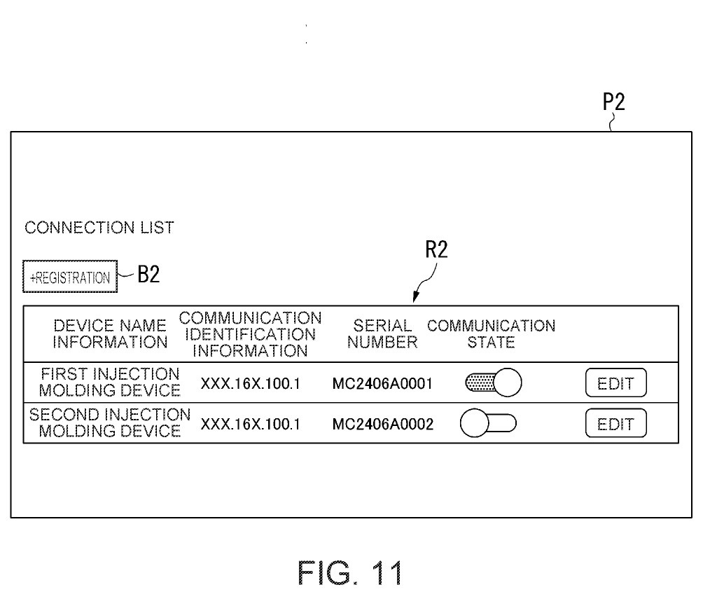

FIG. 10 is a diagram showing a state in which one of the two common IP injection molding devices is connected to the information processing device 20. The first injection molding device and the second injection molding device shown in FIG. 10 are assigned the IP address “XXX.16X.100.1" as common communication identification information. In the example shown in FIG. 10, the information processing device 20 switches the connected injection molding device from a state of being communicably connected to the first injection molding device to a state of being communicably connected to the second injection molding device. In FIG. 10, the flow of this switching is indicated by "CONNECTION CHANGE". The information processing device 20 can execute switching of the connected injection molding device to another injection molding device in this manner in a software manner by receiving an operation via the communication destination specifying image P2 as shown in FIG. 11, for example.

FIG. 11 is a diagram showing an example of a communication destination specifying image P2. The communication destination specifying image P2 is an image including a GUI that receives an operation of switching which of the two or more common IP injection molding devices that can be connected is caused to communicate with the information processing device 20. The communication destination specifying image P2 includes, for example, a region R2 in which a list of the device related information indicating each of the two or more common IP injection molding devices that can be connected is displayed, and a button B2. Note that the communication destination specifying image P2 may be configured to include other GUIs in addition to the region R2 and the button B2. In the example shown in FIG. 11, the device related information indicating each of the two or more common IP injection molding devices displayed in the region R2 includes the device name information, the communication identification information, and the serial number of the common IP injection molding device. In the region R2, switches for receiving an operation of switching the communication state with the information processing device 20 are displayed in association with each common IP injection molding device. However, the user can turn on only one of the two or more switches displayed in the region R2. That is, the communication destination specifying image P2 receives an operation of specifying one of the two or more common IP injection molding devices as a communication destination and excluding the remaining ones of the two or more common IP injection molding devices as a communication destination, as an operation of switching which of the two or more common IP injection molding devices the information processing device 20 is caused to communicate with. This is because two or more common IP injection molding devices cannot be in a state of enabling duplicate communication with the information processing device 20. Note that the state in which a certain switch displayed in the region R2 is ON indicates that the common IP injection molding device indicated by the device related information displayed in association with the switch among the two or more common IP injection molding devices is connected to the information processing device 20. That is, the state in which a certain switch displayed in the region R2 is OFF indicates that the common IP injection molding device indicated by the device related information displayed in association with the switch among the two or more common IP injection molding devices is not connected to the information processing device 20. In the example shown in FIG. 11, the switch displayed in association with the device related information indicating the first injection molding device shown in FIG. 10 is in the ON state. On the other hand, in the present example, the switch displayed in association with the device related information indicating the second injection molding device shown in FIG. 10 is in the OFF state.

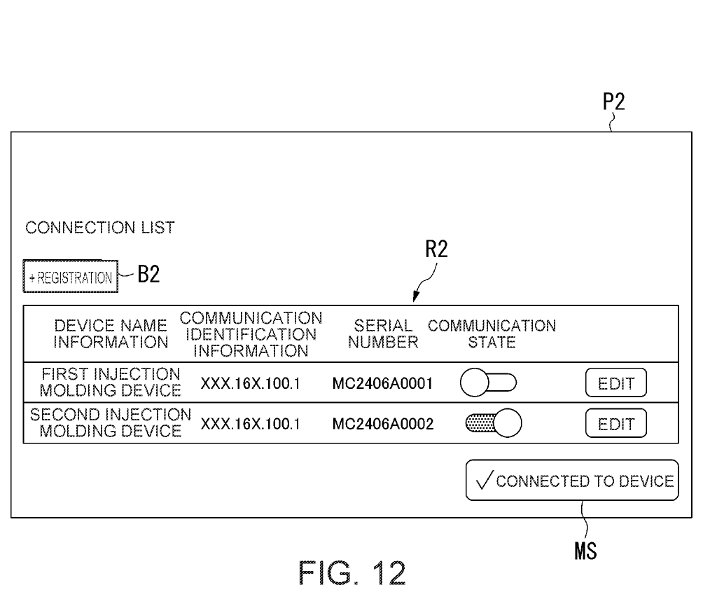

Here, FIG. 12 is a diagram shown an example of a switch state switched from that shown in FIG. 11. In the example shown in FIG. 12, unlike the example shown in FIG. 11, the switch displayed in association with the device related information indicating the first injection molding device shown in FIG. 10 is in the OFF state. On the other hand, in the present example, the switch displayed in association with the device related information indicating the second injection molding device shown in FIG. 10 is in the ON state. In the communication destination specifying image P2, when the switch state is switched in this manner and communication between the information processing device 20 and the common IP injection molding device is established, information MS indicating that communication is established is displayed as shown in FIG. 12. In the example shown in FIG. 12, the information MS is a message including a character string "CONNECTED TO DEVICE", but is not limited to this.

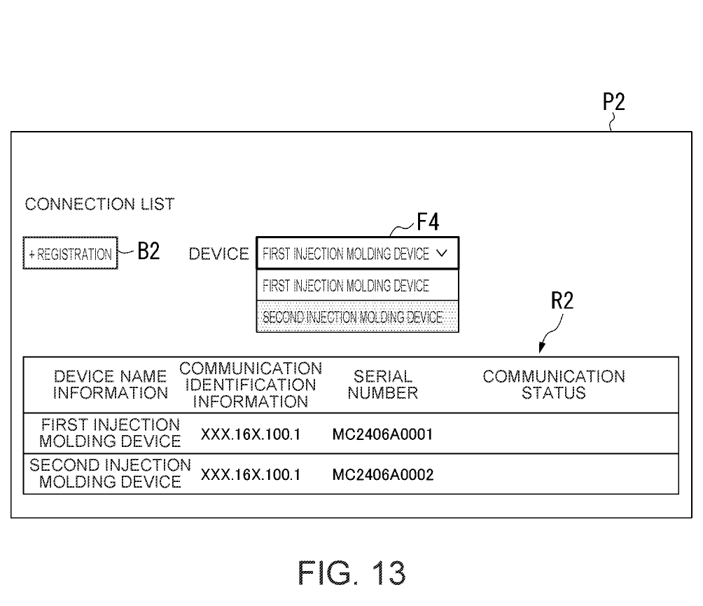

Note that the information processing device 20 may be configured to receive an operation of selecting the common IP injection molding device desired by the user to establish communication with the information processing device 20 from among the two or more common IP injection molding devices, for example, by a pull-down menu as shown in FIG. 13, instead of the switch described above, in the communication destination specifying image P2. FIG. 13 is a diagram showing another example of the communication destination specifying image P2. In the communication destination specifying image P2 shown in FIG. 13, a switch that receives an operation of switching the communication state with the information processing device 20 is not displayed in association with each device related information. Instead, the communication destination specifying image P2 shown in FIG. 13 includes an input field F4.

The input field F4 is a field in which is input information indicating the common IP injection molding device desired by the user to establish communication with the information processing device 20, among the common IP injection molding devices indicated by the two or more-device related information displayed in the region R2. In the example shown in FIG. 13, "FIRST INJECTION MOLDING DEVICE", which is one of the device name information included in the device related information displayed in the region R2, is displayed in the input field F4. Note that the information may be input to the input field F4 by selecting the information from the pull-down menu or by directly inputting the information using an input device such as a keyboard. In the present example, the device name information is input to the input field F4 by selecting the device name information from the pull-down menu. Note that the input field F4 may be a field in which device identification information is input instead of the device name information.

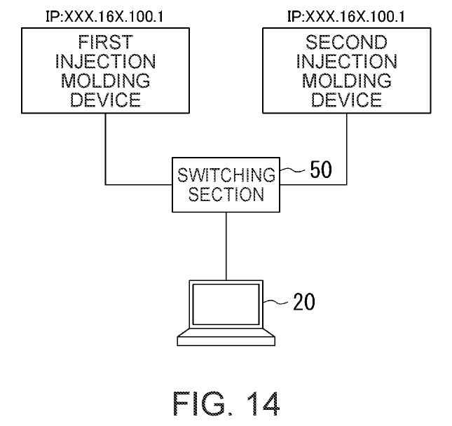

The information processing device 20 may be configured to receive the switching of the connected common IP injection molding device to another common IP injection molding device by hardware, for example, by a switching section 50 as shown in FIG. 14. FIG. 14 is a diagram showing an example of a state in which the information processing device 20 connected to one of the two common IP injection molding devices via the switching section 50.

The switching section 50 is a switcher that switches between the two or more common IP injection molding devices with which the information processing device 20 is caused to communicate. In the example shown in FIG. 14, the switching section 50 is connected between each of the two common IP injection molding devices and the information processing device 20. Therefore, in the present example, the switching section 50 switches which of the two common IP injection molding devices that the information processing device 20 is caused to communicate with. In this case, the user can intuitively establish communication between the desired common IP injection molding device and the information processing device 20 without operating the information processing device 20. In this case, the molding management system 1 includes the switching section 50. Note that the switching section 50 is separate from the information processing device 20 in the example shown in FIG. 14, but may be configured integrally with the information processing device 20.

### About storage of history information by information processing device X

The information processing device X may be configured to store at least one of first history information and second history information in the storage section 32.

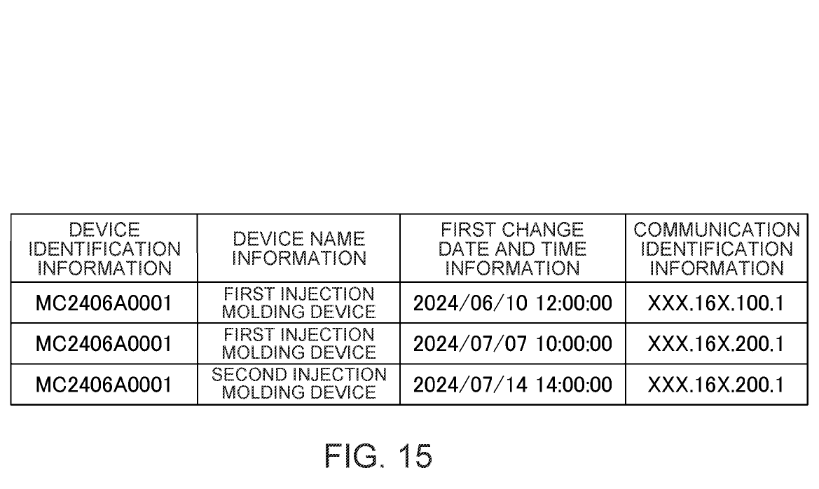

Here, first history information is information indicating a history of changes in at least one of the communication identification information and the device name information associated with each device identification information stored in the storage section 32. Hereinafter, as an example, as shown in FIG. 15, a case will be described in which the first history information is information indicating a history of changes of both the communication identification information and the device name information associated with each device identification information stored in the storage section 32. FIG. 15 is a diagram showing an example of first history information. FIG. 15 shows first history information indicating the history of changes in both the device name information and the communication identification information associated with the device identification information "MC2406A0001". For example, in the first history information, as shown in FIG. 15, first change date and time information indicating a date and time when at least one of the device name information and the communication identification information associated with the device identification information was changed, and the device name information and the communication identification information after the date and time indicated by the first change date and time information are associated with the device identification information. For example, the first history information shown in FIG. 15 indicates that the device name information associated with the device identification information "MC2406A0001" was changed from "FIRST INJECTION MOLDING DEVICE" to "SECOND INJECTION MOLDING DEVICE" at 14:00:00 on Jul. 14, 2024. For example, the first history information shown in FIG. 15 indicates that the communication identification information associated with the device identification information "MC2406A0001" was changed from "XXX.16X.100.1" to "XXX.16X.200.1" at 10:00:00 on Jul. 7, 2024.

The information processing device X generates the first history information in response to, for example, a change in at least one of the device name information and the communication identification information associated with the device identification information, and stores the generated first history information in the storage section 32. Note that the method of generating the first history information by the information processing device X may be a known method or a method to be developed in the future.

The information processing device X may be configured to display such first history information in accordance with the received operation, or may be configured to output the first history information to another device. The other device is the terminal device 40 or the like, but is not limited thereto.

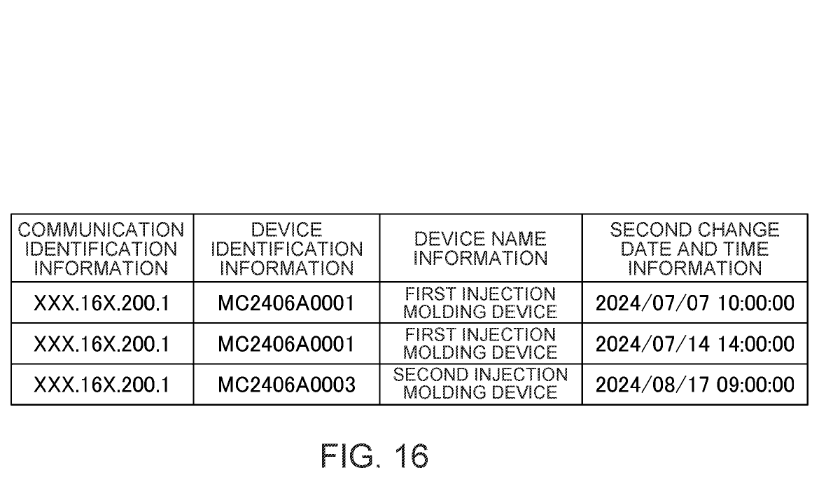

The second history information is information indicating a history of changes in at least one of the device identification information and the device name information associated with each communication identification information stored in the storage section 32. Hereinafter, as an example, a case will be described in which, as shown in FIG. 16, the second history information is information indicating a history of changes in both the device identification information and the device name information, which are associated with each communication identification information that is stored in the storage section 32. FIG. 16 is a diagram showing an example of a second history information. FIG. 16 shows the second history information indicating the history of changes in both the device identification information and the device name information associated with the communication identification information "XXX.16X.200.1". For example, in the second history information, as shown in FIG. 16, second change date and time information indicating a date and time when at least one of the device identification information and the device name information associated with the communication identification information is changed, and the device identification information and the device name information after the date and time indicated by the second change date and time information are associated with the communication identification information. For example, the second history information shown in FIG. 16 indicates that the device identification information associated with the communication identification information “XXX.16X.200.1" was changed from "MC2406A0001" to "MC2406A0003" at 9:00:00 on Aug. 17, 2024. For example, the second history information shown in FIG. 16 indicates that the device name information associated with the communication identification information “XXX.16X.200.1" was changed from "FIRST INJECTION MOLDING DEVICE" to "SECOND INJECTION MOLDING DEVICE" at 9:00:00 on Aug. 17, 2024.

The information processing device X generates the second history information in response to, for example, a change in at least one of the device identification information and the device name information associated with the communication identification information, and stores the generated second history information in the storage section 32. Note that the method of generating the second history information by the information processing device X may be a known method or a method to be developed in the future.

The information processing device X may be configured to display such second history information in accordance with the received operation, or may be configured to output the second history information to another device. The other device is the terminal device 40 or the like, but is not limited thereto.

As described above, the information processing device X stores at least one of the first history information and the second history information in the storage section 32, and thus can facilitate management of the device identification information, management of the communication identification information, and the like.

Process in which information processing device 20 updates first correspondence information and second correspondence information to latest information

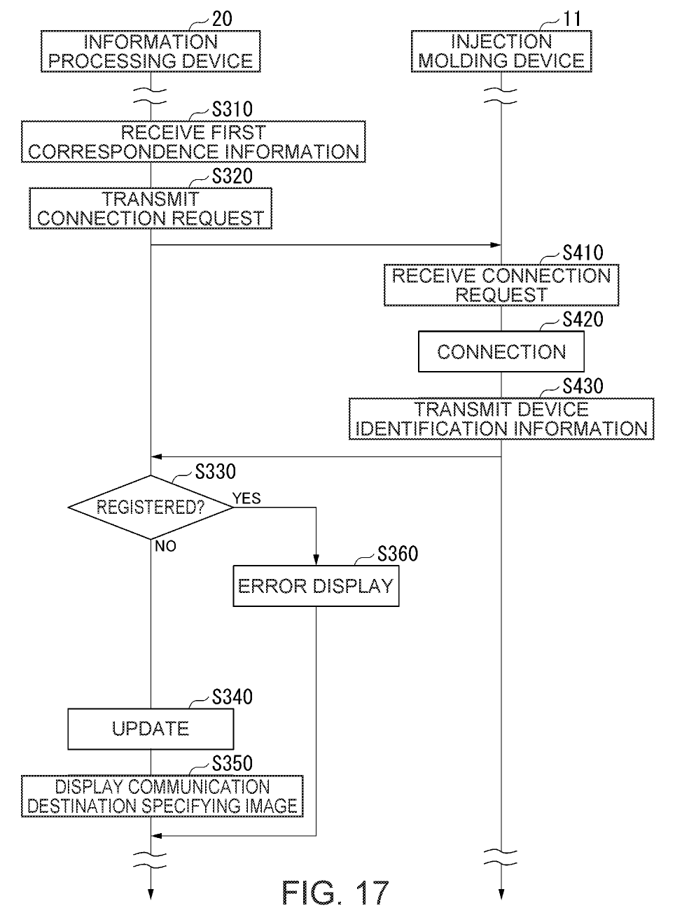

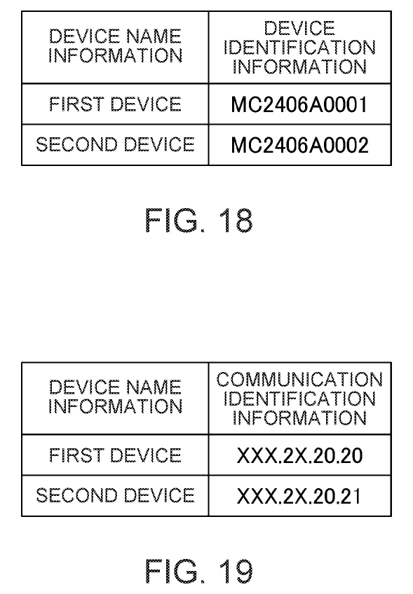

Hereinafter, a process will be described with reference to FIG. 17, in which the information processing device 20 updates first correspondence information and second correspondence information to the latest information. The process is executed by the information processing device 20, for example, when the information processing device 20 establishes communication with the injection molding device. FIG. 17 is a sequence diagram showing an example of a process flow in which the information processing device 20 updates the first correspondence information and the second correspondence information described above to the latest information. Hereinafter, as an example, a case will be described in which the second correspondence information is stored in the storage section 32 at a timing before the process of step S310 shown in FIG. 17 is performed. Here, FIG. 18 is a diagram showing an example of the second correspondence information. In the example shown in FIG. 18, the device identification information "MC2406A0001" is associated with "FIRST DEVICE" as device name information. In the present example, the device identification information "MC2406A0002" is associated with "SECOND DEVICE" as device name information. The correspondence between the device name information and the device identification information may be changed for management reasons. For example, for management reasons such as a layout change in the factory, the "SECOND DEVICE" may be associated with the device identification information "MC2406A0001", and the “FIRST DEVICE" may be associated with the device identification information "MC2406A0002". Therefore, it is desirable that the second correspondence information is always updated to the latest information. Hereinafter, as an example, a case will be described in which the first correspondence information is stored in the storage section 32 at the timing. Here, FIG. 19 is a diagram showing an example of first correspondence information. In the example shown in FIG. 19, the device name information "FIRST DEVICE" is associated with "XXX.2X.20.20" as communication identification information. In the present example, the device name information "SECOND DEVICE" is associated with "XXX.2X.20.21" as communication identification information. The first correspondence information stored in advance in the storage section 32 is first correspondence information received by the information processing device 20 in the past. When the information processing device 20 is reconnected to each injection molding device, it may not be known whether or not the first correspondence information is the latest information. This is because the correspondence relationship between the device name information and the communication identification information may also be changed due to management reasons, such as a layout change in the factory, similar to the correspondence relationship between the device name information and the device identification information. Therefore, it is desirable that the first correspondence information is also always updated to the latest information. Hereinafter, as an example, a case will be described in which, when the information processing device 20 establishes communication with the injection molding device, the information processing device 20 receives new first correspondence information. That is, hereinafter, as an example, a case in which the information processing device 20 receives new first correspondence information when receiving an operation by the user to connect the information processing device 20 to a certain injection molding device. The first correspondence information newly received by the information processing device 20 is first correspondence information for associating the device name information and the communication identification information recognized as being associated by the user at the time when the user attempts to connect the information processing device 20 to a certain injection molding device. Hereinafter, as an example, a case will be described in which the information processing device 20 displays a first correspondence information receiving image P3 for receiving the first correspondence information at the timing.

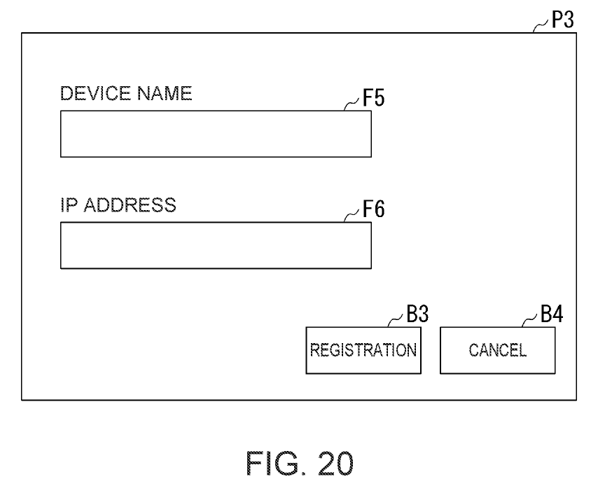

After the first correspondence information receiving image P3 is received, the control section 34 displays the first correspondence information receiving image P3 (step S310). In FIG. 17, the process of step S310 is indicated by “RECEIVE FIRST CORRESPONDENCE INFORMATION". FIG. 20 is a diagram showing an example of the first correspondence information receiving image P3. The first correspondence information receiving image P3 includes, for example, an input field F5, an input field F6, a button B3, and a button B4. Note that the first correspondence information receiving image P3 may be configured to include other GUIs in addition to the input field F5, the input field F6, the button B3, and the button B4.

The input field F5 is a field in which the device name information indicating the name of the desired injection molding device to be connected to the information processing device 20 by the user is input. In the example shown in FIG. 20, nothing is input in the input field F5. Note that the information may be input to the input field F5 by selecting the device name information from a pull-down menu or by directly inputting the information using an input device such as a keyboard.

The input field F6 is a field in which is input the communication identification information recognized by the user as being assigned to the injection molding device having the name indicated by the device name information that was input in the input field F5. In the example shown in FIG. 20, nothing is input in the input field F6. Note that the information may be input to the input field F6 by selecting the communication identification information from a pull-down menu or by directly inputting the information using an input device such as a keyboard.

The button B3 is a button that receives an operation for starting the connection of the information processing device 20 to the injection molding device to which the communication identification information input in the input field F6 is assigned. When the selection operation is performed on the button B3, the information processing device 20 transmits a connection request to the injection molding device to the injection molding device based on the communication identification information.

The button B4 is a button that receives an operation of stopping the connection of the information processing device 20 to the injection molding device to which the communication identification information input in the input field F6 is assigned. When the selection operation is performed on the button B4, the information processing device 20 deletes the display of the first correspondence information receiving image P3 on the terminal device 40, and stops the connection, for example.

The control section 34 receives the first correspondence information from the user via the first correspondence information receiving image P3 in step S310. Therefore, in the following, a case will be described in which the device name information is input to the input field F5, the communication identification information is input to the input field F6, and the selection operation is performed on the button B3 in step S310.

After the selection operation on the button B3 is performed, the control section 34 transmits a connection request of the information processing device 20 to the injection molding device to which the communication identification information input in the input field F6 is assigned, to the injection molding device (step S320). In FIG. 17, the process of step S320 is indicated by "TRANSMIT CONNECTION REQUEST". In the following description, for convenience of description, the injection molding device will be referred to as a connection target injection molding device. Hereinafter, as an example, as shown in FIG. 17, a case will be described in which the connection target injection molding device is the injection molding device 11. Hereinafter, as an example, a case will be described in which the request includes a request for acquisition of the device identification information assigned to the connection target injection molding device. Note that the request for acquisition of the device identification information may be configured to transmit from the information processing device 20 to the connection target injection molding device separately from the connection request.

Next, the connection target injection molding device receives the connection request from the information processing device 20 (step S410). In FIG. 17, the process of step S410 is indicated by "RECEIVE CONNECTION REQUEST".

Next, the connection target injection molding device establishes communication with the information processing device 20 (step S420). In FIG. 17, the process of step S420 is indicated by "CONNECTION". Note that the method of establishing communication between the connection target injection molding device and the information processing device 20 in step S420 may be a known method or a method to be developed in the future.

Next, the connection target injection molding device transmits the device identification information assigned to the connection target injection molding device to the information processing device 20 (step S430). That is, in the example shown in FIG. 17, the connection target injection molding device passively transmits the device identification information to the information processing device 20 in response to the request from the information processing device 20. In FIG. 17, the process of step S043 is indicated by "TRANSMIT DEVICE IDENTIFICATION INFORMATION".

Next, the control section 34 receives the device identification information from the connection target injection molding device. Then, based on the received device identification information and the second correspondence information stored in advance in the storage section 32, the information processing device 20 determines whether or not the device name information associated with the device identification information matches the device name information associated with the device identification information in the first correspondence information received in step S310 (step S330). In FIG. 17, the process of step S330 is indicated by "REGISTERED?".

If the control section 34 determines that the device name information associated with the received device identification information matches the device name information associated with the device identification information in the first correspondence information received in step S310 (step S330: YES), the control section 34 displays information MS2 indicating that the first correspondence information received in step S310 is already stored in the storage section 32 on the first correspondence information receiving image P3 (step S360). In FIG. 17, the process of step S360 is indicated by "ERROR DISPLAY".

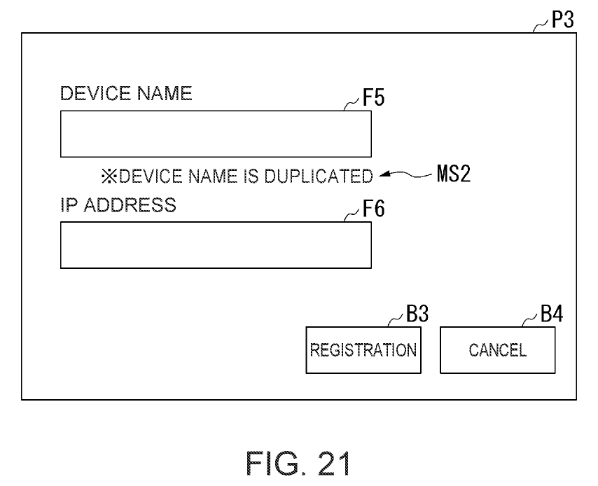

Here, FIG. 21 is a diagram showing an example of the first correspondence information receiving image P3 in which information MS2 is displayed. In the example shown in FIG. 21, a text string "※ DEVICE NAME IS DUPLICATED" is displayed as the information MS2 in the first correspondence information receiving image P3. By this, the user can easily grasp that the injection molding device that attempts to connect to the information processing device 20 was the desired injection molding device.

On the other hand, if the control section 34 determines that the device name information associated with the received device identification information does not match the device name information associated with the device identification information in the first correspondence information received in step S310 (step S330: NO), the control section 34 updates the first correspondence information and the second correspondence information stored in the storage section 32 (step S340). Specifically, in step S340, the control section 34 replaces the first correspondence information including the communication identification information included in the first correspondence information received in step S310, among the first correspondence information stored in the storage section 32, with the first correspondence information received in step S310. In step S340, the control section 34 replaces the second correspondence information including the device identification information included in the first correspondence information received in step S310, among the second correspondence information stored in the storage section 32, with the second correspondence information associating the device identification information received in step S330 with the device name information included in the first correspondence information. In FIG. 17, the process of step S340 is indicated by "UPDATE".

Next, for example, in a case where the communication destination specifying image P2 is displayed, the control section 34 generates the communication destination specifying image P2 based on the updated first correspondence information and second correspondence information and displays the generated communication destination specifying image P2 (step S350). In FIG. 17, the process of step S350 is indicated by "DISPLAY COMMUNICATION DESTINATION SPECIFYING IMAGE". Note that the process performed after the process of step S340 is performed is not limited to the process of step S350.

Through the sequence described above, the information processing device 20 can update the first correspondence information and the second correspondence information to the latest information. By this, the information processing device 20 can prevent an unintended injection molding device from being connected to the information processing device 20, and as a result, can facilitate management of the injection molding device connected to the information processing device 20.

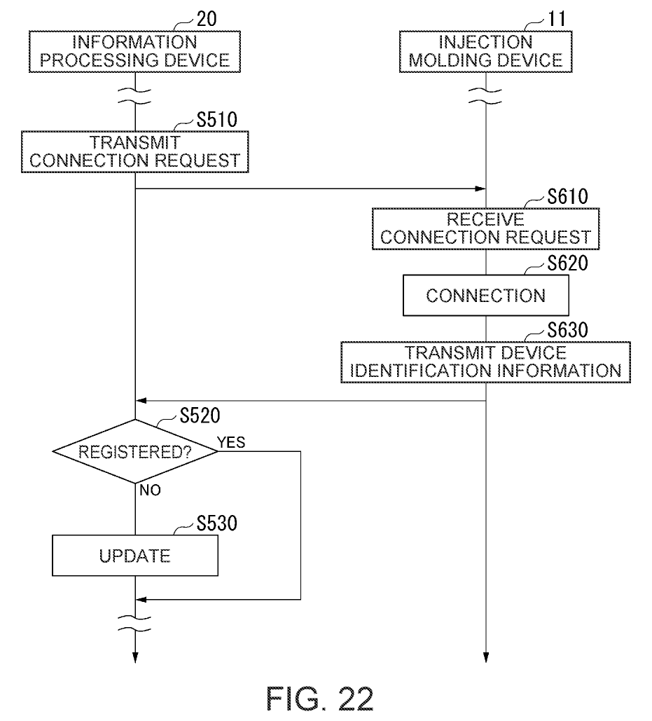

Note that the information processing device 20 may be configured to update the first correspondence information to the latest information by executing the process according to the sequence diagram shown in FIG. 22 instead of the sequence diagram shown in FIG. 17. FIG. 22 is a sequence diagram showing another example of the process flow in which the information processing device 20 updates the first correspondence information to the latest information. Hereinafter, as an example, a case will be described in which, at a timing before the process of step S510 shown in FIG. 22 is performed, the information processing device 20 receives the operation of causing the information processing device 20 to broadcast the connection request to each of one or more injection molding devices in a state of being able to establish communication with the information processing device 20. Hereinafter, as an example, a case will be described in which the injection molding device in a state where communication with the information processing device 20 can be established is only the injection molding device 11. Hereinafter, as an example, a case will be described in which the first correspondence information is stored in the storage section 32 at the timing.

After receiving the operation of broadcasting the connection request, the control section 34 transmits the connection request to the injection molding device 11 (step S510). In FIG. 22, the process of step S510 is indicated by "TRANSMIT CONNECTION REQUEST".

Next, the injection molding device 11 receives the connection request from the information processing device 20 (step S610). In FIG. 22, the process of step S610 is indicated by "RECEIVE CONNECTION REQUEST".

Next, the injection molding device 11 establishes communication with the information processing device 20 (step S620). In FIG. 22, the process of step S620 is indicated by "CONNECTION". Note that the method of establishing communication between the connection target injection molding device and the information processing device 20 in step S620 may be a known method or a method to be developed in the future.

Next, the injection molding device 11 transmits the device identification information assigned to the injection molding device 11 to the information processing device 20 (step S630). That is, in the example shown in FIG. 22, the injection molding device 11 actively transmits the device identification information to the information processing device 20. In FIG. 22, the process of step S630 is indicated by "TRANSMIT DEVICE IDENTIFICATION INFORMATION".

Next, the control section 34 receives the device identification information from the injection molding device 11. Then, based on the received device identification information and the second correspondence information stored in advance in the storage section 32, the information processing device 20 determines whether or not the device name information associated with the device identification information matches the device name information associated with the device identification information in the first correspondence information stored in advance in the storage section 32 (step S520). In FIG. 22, the process of step S520 is indicated by "REGISTERED?".

If the control section 34 determines that the device name information associated with the received device identification information matches the device name information associated with the device identification information in the first correspondence information stored in advance in the storage section 32 (YES in step S520), the control section 34 does nothing and waits until a new operation is received from the user.

On the other hand, if the control section 34 determines that the device name information associated with the received device identification information does not match the device name information associated with the device identification information in the first correspondence information stored in advance in the storage section 32 (step S520: NO), the control section 34 updates the first correspondence information stored in the storage section 32 (step S530). Specifically, the control section 34 specifies the communication identification information indicating the transmission source of the device identification information in step S530. The method of specifying the communication identification information may be a known method, such as a method of analyzing a header, or may be a method to be developed in the future. After specifying the communication identification information, the control section 34 replaces the first correspondence information including the received device identification information among the first correspondence information stored in the storage section 32 with the first correspondence information in which the received device identification information and the communication identification information are associated with each other. In FIG. 22, the process of step S530 is indicated by "UPDATE".

Through the sequence described above, the information processing device 20 can update the first correspondence information to the latest information. Also in this way, the information processing device 20 can prevent an unintended injection molding device from being connected to the information processing device 20 and, as a result, can facilitate management of the injection molding device connected to the information processing device 20.

Specific example of situation in which injection molding device connected to information processing device 20 is changed

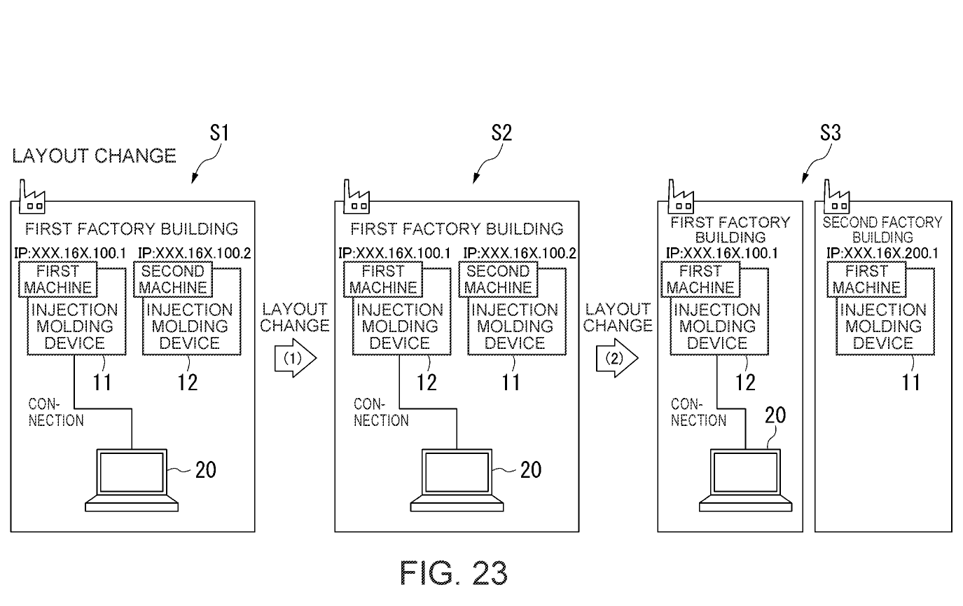

Hereinafter, a specific example will be described with reference to FIG. 23 of a situation in which the injection molding device connected to the information processing device 20 is changed. FIG. 23 is a diagram for explaining the specific example of the situation in which the injection molding device connected to the information processing device 20 is changed. In a first factory building indicated by reference symbol S1, the injection molding device 11 and an injection molding device 12 are physically connected to the information processing device 20 by a communication cable as injection molding devices in a state of being able to establish communication with the information processing device 20. Within the first factory building, the name "FIRST MACHINE" is assigned to the injection molding device 11. Within the first factory building, the name "SECOND MACHINE" is assigned to the injection molding device 12. In the first factory building, the information processing device 20 has established communication with the injection molding device 11 by software or hardware, and has not established communication with the injection molding device 12. The position of the injection molding device 11 within the first factory building may be exchanged with the position of the injection molding device 12 due to a layout change. In FIG. 23, the first factory building after such a position exchange is performed is the first factory building indicated by the reference symbol S2. In this case, as shown in FIG. 23, the communication identification information assigned to the injection molding device 11 and the communication identification information assigned to the injection molding device 12 may have been switched. Further, in this case, within the first factory building, the name assigned to the injection molding device 11 is changed from "FIRST MACHINE" to "SECOND MACHINE". Therefore, within the first factory building, the name assigned to the injection molding device 12 is changed from "SECOND MACHINE" to "FIRST MACHINE". Within the first factory building, the information processing device 20 has established communication with the injection molding device 12 by software or hardware, and has not established communication with the injection molding device 11. In such a state, the injection molding device 11 is not being used, and may start to be used for another purpose. As a result, the injection molding device 11 may be moved from the first factory building to a second factory building, indicated by reference symbol S3. In this case, the communication identification information assigned to the injection molding device 11 in the second factory building may be, as shown in FIG. 23, the communication identification information different from the communication identification information that can be assigned to the injection molding device 11 in the first factory building. Further, within the second factory building, the name of the injection molding device 11 is changed to "FIRST MACHINE".

As described above, the name and the communication identification information assigned to the injection molding device in the factory may be changed for management reasons, such as a layout change in the factory. In such a case, if it is not possible to specify from which injection molding device each of the injection molding related data stored in the storage section 32 of the information processing device X is acquired, it is difficult to precisely manage the product molded by injection molding. In order to solve such a problem, the injection molding related data associated with the device identification information is stored in the storage section 32 of the information processing device X. By this, the information processing device X can easily specify the injection molding device of the transmission source of the data acquired in the past.

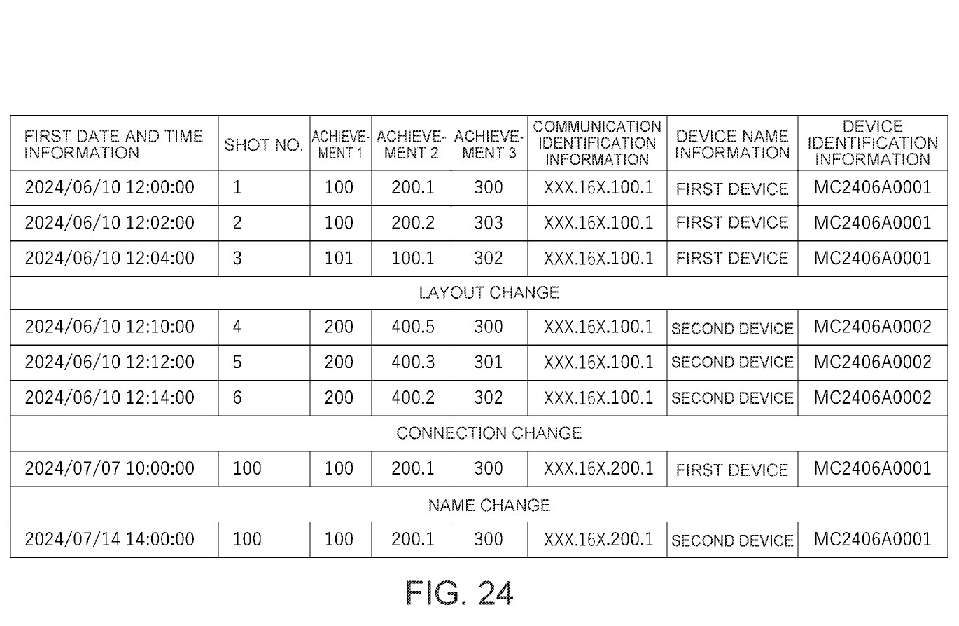

For example, FIG. 24 is a diagram showing an example of the injection molding related data acquired by the information processing device 20 from the injection molding device in chronological order. However, in FIG. 24, the timing at which the layout change in the factory occurs is indicated by a row described as "LAYOUT CHANGE". In FIG. 24, the timing at which the injection molding device connected to the information processing device 20 in the factory is changed is indicated by "CONNECTION CHANGE". In FIG. 24, the timing at which the name of the injection molding device is changed in the factory is indicated by "NAME CHANGE". The type of the injection molding related data shown in FIG. 24 is cycle data.

The cycle data shown in FIG. 24 includes cycle data in which the device name information, the communication identification information, and the like are duplicated with each other. However, each of the cycle data shown in FIG. 24 is configured to be able to specify, using the device identification information, from which injection molding device the cycle data was acquired by the information processing device 20. In this way, when the storage section 32 stores the injection molding related data associated with the device identification information, the information processing device X can easily specify the injection molding device of the transmission source of the data acquired in the past.

Note that the molding management system 1 described above may be configured to include the terminal device 40. The molding management system 1 described above may be configured to include an injection molding device such as the injection molding device 11.

The information processing device 20 described above may be configured to associate a plurality of injection molding condition data with one piece of cycle data.

The contents described above may be combined in any manner.

### Appendix

A molding management system for managing production of a product in a production process including an injection molding process of the product by an injection molding device, the molding management system includes an information processing device communicatively connected to a terminal device, wherein the information processing device includes a storage section configured to store data relating to an injection molding and the data is associated with information unique to the injection molding device as device identification information for identifying the injection molding device.

The molding management system according to [1], wherein the device identification information is at least one of a serial number, a Media Access Control address, a model number, and an ID assigned to the injection molding device.

The molding management system according to [1] or [2], wherein the data is associated with communication identification information assigned to the injection molding device of a transmission source separately from the device identification information.

The molding management system according to any one of [1] to [3], wherein the storage section stores, for each set of the device identification information, first correspondence information in which the device identification information is associated with communication identification information assigned to the injection molding device.

The molding management system according to any one of [1] to [4], wherein the information processing device is communicably connected to any one of two or more of the injection molding devices to which common communication identification information is assigned and includes a control section configured to cause a display section to display a communication destination specifying image that receives an operation of switching which of the two or more injection molding devices that the information processing device is to be caused to communicate with.

The molding management system according to [5], wherein the communication destination specifying image receives, as an operation of switching which of the two or more injection molding devices that the information processing device is to be caused to communicate with, an operation of designating one of the two or more injection molding devices as a communication destination and excluding the remaining of the two or more injection molding devices as a communication destination.

The molding management system according to [5], wherein the communication destination specifying image includes a GUI that receives an operation of switching which of the two or more injection molding devices that the information processing device is to be caused to communicate with.

The molding management system according to any one of [1] to [7], wherein the information processing device is communicably connected to one of two or more injection molding devices to which common communication identification information is assigned and the molding management system includes a switching section that switches between the two or more injection molding devices with which the information processing device is to be caused to communicate with.

The molding management system according to any one of [1] to [8], wherein the data is at least one piece of cycle data, injection molding condition data, and operational status history data.

The molding management system according to any one of [1] to [9], wherein the storage section stores, for each set of the device identification information, second correspondence information in which the device identification information and device name information indicating a name of the injection molding device are associated with each other and

the information processing device includes a control section configured to receive device name information indicating a name of the injection molding device, specify the device identification information associated with the received device name information based on the second correspondence information, and display a list of the data including the specified device identification information on a display section.

The molding management system according to any one of [1] to , wherein the storage section stores first history information indicating a history of changes in at least one of communication identification information and device name information associated with the device identification information and the device name information is information indicating a name of the injection molding device.

The molding management system according to any one of [1] to , wherein the storage section stores second history information indicating a history of changes in at least one of the device identification information and the device name information associated with the communication identification information and the device name information is information indicating a name of the injection molding device.

The molding management system according to any one of [1] to , wherein the injection molding device is configured to store the device identification information of the injection molding device and the information processing device includes a control section configured to acquire the device identification information stored in the injection molding device from the injection molding device in response to a received operation.

The molding management system according to , wherein the storage section stores, for each set of the device identification information, first correspondence information in which the device identification information is associated with communication identification information assigned to the injection molding device and the control section is configured to determine whether or not a combination of the device identification information acquired from the injection molding device and the communication identification information assigned to the injection molding device is associated in the first correspondence information, and causes a display section to display information indicating a result of the determination.

The molding management system according to any one of [1] to , further including the terminal device.

The molding management system according to any one of [1] to , further including the injection molding device.

Although the embodiments of the present disclosure have been described in detail with reference to the drawings, specific configurations are not limited to the embodiments, and changes, substitutions, deletions, and the like may be made without departing from the gist of the present disclosure.

A program for implementing the functions of any of the components in the above described device may be recorded on a computer-readable recording medium, and the program may be read into a computer system for execution. Here, the device is, for example, the injection molding device 11, the information processing device 20, the server 30, the terminal device 40, or the like. Note that the "computer system" referred to here includes an Operating System (OS) and hardware such as peripheral devices. The "computer-readable recording medium" refers to a portable medium such as a flexible disk, a magneto-optical disk, a ROM, a Compact Disk (CD) - ROM, or a storage device such as a hard disk built into the computer system. Furthermore, the "computer-readable recording medium" includes a medium that holds a program for a certain period of time, such as a volatile memory inside a computer system serving as a server or a client when the program is transmitted via a network such as the Internet or a communication line such as a telephone line.

The program may be transmitted from a computer system in which the program is stored in a storage device or the like to another computer system via a transmission medium or by a transmission wave in the transmission medium. Here, the "transmission medium" for transmitting the program refers to a medium having a function of transmitting information, such as a network, such as the Internet, or a communication line, such as a telephone line.

The program may be a program for realizing a part of the above described functions. Furthermore, the program may be a so-called differential file or differential program that can realize the above described functions in combination with a program already recorded in the computer system.

What is claimed is:

1. A molding management system for managing production of a product in a production process including an injection molding process of the product by an injection molding device, the molding management system comprising:
an information processing device communicatively connected to a terminal device, wherein
the information processing device includes a storage section configured to store data relating to an injection molding and
the data is associated with information unique to the injection molding device as device identification information for identifying the injection molding device.

2. The molding management system according to claim 1, wherein
the device identification information is at least one of a serial number, a Media Access Control address, a model number, and an ID assigned to the injection molding device.

3. The molding management system according to claim 1, wherein
the data is associated with communication identification information assigned to the injection molding device of a transmission source separately from the device identification information.

4. The molding management system according to claim 1, wherein
the storage section stores, for each set of the device identification information, first correspondence information in which the device identification information is associated with communication identification information assigned to the injection molding device.

5. The molding management system according to claim 1, wherein
the information processing device
is communicably connected to any one of two or more of the injection molding devices to which common communication identification information is assigned and
includes a control section configured to cause a display section to display a communication destination specifying image that receives an operation of switching which of the two or more injection molding devices that the information processing device is to be caused to communicate with.

6. The molding management system according to claim 5, wherein
the communication destination specifying image receives, as an operation of switching which of the two or more injection molding devices that the information processing device is to be caused to communicate with, an operation of designating one of the two or more injection molding devices as a communication destination and excluding the remaining of the two or more injection molding devices as a communication destination.

7. The molding management system according to claim 5, wherein
the communication destination specifying image includes a GUI that receives an operation of switching which of the two or more injection molding devices that the information processing device is to be caused to communicate with.

8. The molding management system according to claim 1, wherein
the information processing device is communicably connected to one of two or more injection molding devices to which common communication identification information is assigned and
the molding management system includes a switching section that switches between the two or more injection molding devices with which the information processing device is to be caused to communicate with.

9. The molding management system according to claim 1, wherein
the data is at least one piece of cycle data, injection molding condition data, and operational status history data.

10. The molding management system according to claim 1, wherein
the storage section stores, for each set of the device identification information, second correspondence information in which the device identification information and device name information indicating a name of the injection molding device are associated with each other and
the information processing device includes a control section configured to receive device name information indicating a name of the injection molding device, specify the device identification information associated with the received device name information based on the second correspondence information, and display a list of the data including the specified device identification information on a display section.

11. The molding management system according to claim 1, wherein
the storage section stores first history information indicating a history of changes in at least one of communication identification information and device name information associated with the device identification information and
the device name information is information indicating a name of the injection molding device.

12. The molding management system according to claim 1, wherein
the storage section stores second history information indicating a history of changes in at least one of the device identification information and the device name information associated with the communication identification information and
the device name information is information indicating a name of the injection molding device.

13. The molding management system according to claim 1, wherein
the injection molding device is configured to store the device identification information of the injection molding device and
the information processing device includes a control section configured to acquire the device identification information stored in the injection molding device from the injection molding device in response to a received operation.

14. The molding management system according to claim 13, wherein
the storage section stores, for each set of the device identification information, first correspondence information in which the device identification information is associated with communication identification information assigned to the injection molding device and
the control section is configured to determine whether or not a combination of the device identification information acquired from the injection molding device and the communication identification information assigned to the injection molding device is associated in the first correspondence information, and causes a display section to display information indicating a result of the determination.

15. The molding management system according to claim 1, further comprising:
the terminal device.

16. Molding management system according to claim 1, further comprising:
the injection molding device.
